(19) United States
(12) Patent Application Publication
(10) Pub. No.: US 2009/0105073 A1
(43) Pub. Date: Apr. 23, 2009

(54) Agrochemical Formulations

(75) Inventors: Claude Taranta, Stutensee (DE); Arnold Kraushaar, Speyer (DE); Matthias Bratz, Maxdorf (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/293,883

(22) PCT Filed: Mar. 20, 2007
(86) PCT No.: PCT/EP2007/052651

§ 371 Date: Sep. 22, 2008

(30) Foreign Application Priority Data
Mar. 24, 2006 (EP) 06111672.9

(51) Int. Cl. A01N 25/00; A01N 47/34; A01P 7/00

(52) U.S. Cl. 504/100; 514/590

(57) ABSTRACT

The present invention relates to non-aqueous agrochemical formulations comprising
(a) at least one pesticide;
(b) at least one organic solvent; and
(c) a mixture comprising a non-ionic distyrylphenol alkoxylate and a ionic distyrylphenol alkoxylate.

The present invention relates to non-aqueous agrochemical formulations comprising
(a) at least one pesticide;
(b) at least one organic solvent; and
(c) a surfactant comprising a mixture comprising a non-ionic distyrylphenol alkoxylate and a ionic distyrylphenol alkoxylate.

It further relates to a method for preparation of a liquid non-aqueous agrochemical formulation comprising contacting at least one pesticide, a organic solvent and an emulsifier comprising a mixture of distyrylphenol alkoxylate and sulfated distyrylphenol alkoxylate.

Moreover it relates to a use of an emulsifier comprising a mixture comprising a non-ionic distyrylphenol alkoxylate and a ionic distyrylphenol alkoxylate a) for reduction of eye toxicity in agrochemical formulations comprising at least one organic solvent and b) for enhancement of efficiency of pesticides in agrochemical formulation comprising at least one organic solvent.

Another aspect of the invention covers a method of combating harmful insects and/or phytopathogenic fungi and a method of controlling undesired vegetation.

This invention also relates to seeds treated with said formulation.

Combinations of preferred embodiments with other preferred embodiments are within the scope of the present invention.

U.S. Pat. No. 5,082,591 discloses non-ionic polyalkoxylated poly(1-phenyl ethyl)phenols for use as surface active agents.

EP 0055401 discloses insecticide compositions containing non-ionic polyalkoxylated poly(1-phenyl ethyl)phenols.

WO 96/01047 (also published as DE 69515663) discloses emulsifiable concentrates comprising a pesticide, an ester as solvent, a dodecyl benzosulfonate and a non-ionic surfactant.

EP 0391171 discloses the synthesis and use of distyryl phenyl-tris-glykol ether as crystallisation inhibitor in an aqueous fungicidal spray.

U.S. Pat. No. 2,993,830 discloses non-ionic polyalkoxylated poly(1-phenyl ethyl)phenols in mixture with sulfonated phenylalkylethers. The latter compounds have a sulfonic acid group bound to the aromatic ring and contain no polyalkoxy groups.

WO2001/20986 discloses polystyrylphenol ethoxylate phosphate in mixture with alkoxylated lignosulfonate salts. In an embodiment further co-surfactants may be present, for example tristyrylphenol ethoxylate. One example discloses a mixture of tristyrylphenol ethoxylate phosphate with alkoxylated lignosulfonate salt and tristyryl phenol ethoxylate.

WO 2006/030006 discloses aqueous microemulsions comprising polyarylphenol polyalkoxyether sulfates or phosphates. As optional emulsifiers ethoxylated castor oils are mentioned.

WO 2001/70024 discloses processes for preparing aqueous formulations of hydrophobic pesticides. In example 1 a mixture of an ethoxylated distyrylphenol and an ethoxylated distyrylphenol sulfate are mixed with aromatic solvent and water to prepare an emulsion. A general guideline is given to formulate an aqueous formulation including providing an aqueous phase and a water-immiscible phase containing the hydrophobic pesticide and one or more emulsifiers.

One of the tasks the formulation chemist is faced with is the development of formulations, which improve the efficiency of pesticides within these formulations.

Furthermore, in formulation development, the use of organic solvents often plays a role, since some pesticide formulations may require the use of organic solvents to enable the processing of pesticides. A problem encountered in the development of such liquid non aqueous agrochemical formulations is that the organic solvents used in said formulation often exhibit significant irritation to eye and are therefore classified as eye irritant. This may lead to registration problems.

The object of the present invention is therefore to provide a non-aqueous formulation that
a) shows improved efficiency of the pesticide used,
b) shows reduction of eye irritation and/or
c) shows chemical and physical stability.

A further object of the invention is to provide a non-aqueous formulation that shows above mentioned characteristics for mixtures of at least two pesticides, wherein one pesticide has a significantly better solubility in water than one of the other pesticides present in the mixture, such as, for example, a mixture of alpha-cypermethrin and acetamiprid.

The object was solved by liquid non-aqueous formulations comprising
(a) at least one pesticide;
(b) at least one organic solvent; and
(c) a surfactant comprising a mixture comprising a non-ionic distyrylphenol alkoxylate and a ionic distyrylphenol alkoxylate.

The term “surfactant” describes a compound, which can have the properties of emulsifying, dispersing or wetting agent or adjuvant.

In a preferred embodiment, the non-ionic distyrylphenol alkoxylates are those of formula I

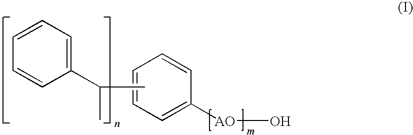

wherein n is 2, and
m is 1 to 40, more preferably 5 to 25, and most preferably 13 to 16,
AO is EO, PO or a mixture of EO and PO moieties, preferably EO.

The terms “EO” and “PO” as used herein have the following meaning:

“EO” is —CH₂—CH₂—O— and “PO” is —CH(CH₃)—CH₂—O—. The term “AO” means “alkoxylate” and is EO, PO or a mixture of EO and PO moiety, preferably EO. Included herein are statistical as well as alternating and block sequences of EO and PO.

More preferred non-ionic distyrylphenol alkoxylates are those of formula Ia

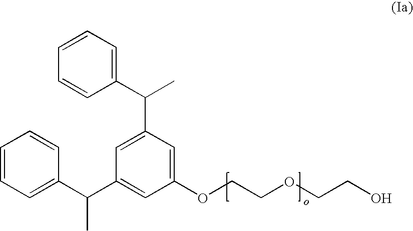

wherein
o is 1 to 40, preferably 5 to 25, more preferably 10 to 20, most preferably 13 to 16.

In a preferred embodiment, the ionic distyrylphenol alkoxylates are those of formula II

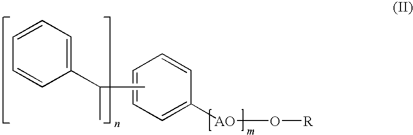

wherein n is 2, and
m is 1 to 40, more preferably 5 to 25, and most preferably 13 to 16,
AO is EO, PO or a mixture of EO and PO moieties, preferably EO; and

### R is SO₃H, H₂PO₃, SO₃X or HPO₃Y

The respective free acid form can be also neutralized with a base, e.g. an alkali metallhydroxide (e.g. NaOH, KOH) or ammonia or an amine (e.g. of formula III

NR¹R²R³ (III)

wherein R¹, R² and R³ are independently from each other hydrogen, methyl, ethyl or propyl, preferably R¹, R² and R³ are ethyl), in aqueous solution resulting in R═SO₃X or HPO₃Y (wherein X and Y represent independently from each other NH₄⁺, (NHR¹R²R³)⁺ with R¹, R² and R³ as defined above, Na⁺ or K⁺).

R is especially preferred SO₃NH₄.

More preferred ionic distyrylphenol alkoxylates are those of formula IIa

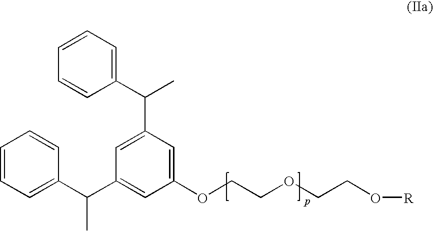

wherein
p is 1 to 40, preferably 5 to 25, more preferably 10 to 20, most preferably 13 to 16; and R is SO₃H, H₂PO₃, SO₃X or HPO₃Y. The respective free acid form can be also neutralized with a base, e.g. an alkali metall hydroxide (e.g. NaOH, KOH) or ammonia or an amine (e.g. of formula III

NR¹R²R³ (III)

wherein R¹, R² and R³ are independently from each other hydrogen, methyl, ethyl or propyl, preferably R¹, R² and R³ are ethyl), in aqueous solution resulting in R═SO₃X or HPO₃Y (wherein X and Y represent independently from each other NH₄⁺, (NHR¹R²R³)⁺ with R¹, R² and R³ as defined above, Na⁺ or K⁺).

R is especially preferred SO₃NH₄.

The preparation of compounds of formula I and Ia is known in the art (see e.g. U.S. Pat. No. 5,082,591). Preparation of compounds of formula II can be performed easily by methods known by the skilled artisan, e.g. phosphatation (e.g. with P₂O₅) or sulfatation (e.g. with H₂NSO₃H) of compounds of formula I or Ia.

Compounds of formula I and/or II are also for instance available in commercial products, for example Soprophor® DSS 15 (Rhodia; ammonium salt of ethoxylated polyarylphenol sulfate, CAS No. 59891-11-1 (corresponds to Poly(oxy-1,2-ethanediyl), alpha.-sulfo-.omega.-[bis(1-phenylethyl)phenoxy]-, ammonium salt), with a specific gravity of 1.15 g/L) or Agrilan® AEC 145 (non-ionic polyaryl ethoxylate with 100% active content, AKZO Nobel).

According to this invention compound c) is a mixture comprising a non-ionic distyrylphenol alkoxylate and a ionic distyrylphenol alkoxylate. The ratio of ionic distyrylphenol alkoxylate to non ionic distyrylphenol alkoxylate can vary in broad ranges, preferably in ranges from 90/10 to 20/80 by weight.

Such compounds c) are for instance commercially available. In general such commercial products comprise non-ionic and ionic distyrylphenol alkoxylates, wherein the non-ionic distyrylphenol alkoxylate can be found in a range from 10 to 50 wt % based on the total product.

The organic solvent (b) is a polar or non-polar solvent or a mixture of a polar and a non-polar solvent, or a mixture of polar solvents, preferably a polar solvent or a mixture of polar solvents.

Examples of non-polar solvents are C8 to C11 aromatic petroleum derivatives (aromatic hydrocarbons) with a solubility in water at room temperature of <0.1% (w/w) and a distillation range from 130° C. to 300° C. (commercially available from ExxonMobil or BP under the following brand names: Solvesso® 100, Solvesso® 150, Solvesso® 200, Solvesso® 150ND, Solvesso® 200ND, Aromatic® 150, Aromatic® 200, Hydrosol® A 200, Hydrosol® A 230/270, Caromax® 20, Caromax® 28, Aromat® K 150, Aromat® K 200, Shellsol® A 150, Shellsol® A 100, Fin® FAS-TX 150, Fin® FAS-TX 200), vegetable oils such as coco oil, palm kern oil, palm oil, soya oil, rapeseed oil, corn oil and the methyl or ethyl esters of the afore-mentioned oils, hydrocarbons such as aromatic depleted, linear paraffinic, isoparaffinic, cycloparaffinic having a flash point between 40° C. and 250° C. and a distillation range between 150° C. and 450° C.

In case mixtures of non-polar solvents with polar solvents are used, non-polar solvents as described above may be employed.

In case only non-polar solvents are used, they are selected from the group consisting of non-aromatic non-polar solvents, preferably from the group consisting of coco oil, palm kern oil, palm oil, soy oil, rapeseed oil, corn oil and the methyl or ethyl esters of the afore-mentioned oils.

Examples of polar solvents are

anisole,
sulfoxides such as dimethylsulfoxide (DMSO); and
lactones such as γ-butyrolactone (GBLO); and
esters such as benzylacetate, benzyl benzoate, butyl benzoate, 2-ethoxypropylacetate, methyl proxitol acetate; tributyl phosphate; and
amides such as N,N-dialkyl alkylamides, preferably fatty acid dimethylamides, more preferably N,N-dimethyl octanamide and/or N,N-dimethyl decanamide (mixtures are commercially available as Hallcomide® M 8-10 from The P.C. Hall Co., Agnique® KE 3658 from Cognis, Genagen® 4166 from Clariant), N-ethyl-2-pyrrolidone (NEP), N-octyl-2-pyrrolidone (NOP), N-methylvalerolactam; and
ketones such as 2-heptanone, cyclohexanone, acetophenone, and acetophenone derivatives such as 4-methoxy acetophenone; and
alcohols such as cyclohexanol, benzyl alcohol, diacetone alcohol, for example 4-hydroxy-4-methyl-2-pentanone, n-octanol, 2-ethylhexanol; and
diesters such as mixtures of dimethyl glutarate and dimethyl succinate and dimethyl adipate (commercially available Rhodiasolv® RPDE from Rhodia), or mixtures of diisobutyl glutarate and diidobutyl succinate and diisobutyl adipate; and
glycol and derivatives such as polyethylene glycol, glycerol, propylene glycol, propylene glycol monomethyl ether acetate, dipropylene glycol monomethyl ether, propylene glycol monophenyl ether; and
alkylene carbonates such as propylene carbonate, butylene carbonate; and
pyrrolidones, derivatives such as N-octylpyrrolidone, N-ethyl pyrrolidone, N-docedyl pyrrolidone; and
lactate esters such as n-propyl lactate, methyl lactate, ethyl lactate, isopropyl lactate, butyl lactate, commercially available under the tradenames PURASOLV® NPL, PURASOLV® ML, PURASOLV® EL, PURASOLV® IPL, PURASOLV® BL or mixtures selected from at least two of the aforementioned solvents.

Preferred polar solvents are DMSO, N-ethyl-2-pyrrolidone, N-octyl-2-pyrrolidone, γ-butyrolactone, acetophenone, 2-heptanone, cyclohexanone, benzyl alcohol, 2-ethylhexanol, fatty acid dimethylamides, N,N-dimethyl octanamide and N,N-dimethyl decanamide, propylene carbonate, a mixture of dimethyl glutarate with dimethyl succinate and with dimethyl adipate, and tributylphosphate.

Also mixtures selected from at least two or preferably at least three of the aforementioned polar solvents are possible.

Preferred mixtures of the aforementioned solvents comprise one or more compounds selected from the following groups: Lactones, N,N-dialkyl alkylamides, sulfoxides, ketones, alkylene carbonates or alcohols.

More preferably mixtures comprise at least two compounds selected from N,N-dialkyl alkylamides; or at least one compound selected from sulfoxides and at least one compound selected from lactones; or at least one compound selected from sulfoxides, at least one compound selected from lactones and at least one compound selected from alcohols; or at least one compound selected from lactones, at least one compound selected from alcohols, at least one compound selected from ketones and at least one compound selected from alkylene carbonates.

Especially preferred mixtures comprise

N,N-dimethyl octanamide and N,N-dimethyl decanamide; or
DMSO and γ-butyrolactone; or
DMSO, γ-butyrolactone and benzyl alcohol; or
γ-butyrolactone, benzyl alcohol, acetophenone and propylene carbonate.

Mixtures of

DMSO and γ-butyrolactone; or of
DMSO, γ-butyrolactone and benzyl alcohol are most preferred.

The term “at least one pesticide” within the meaning of the invention states that one or more compounds can be selected from the group consisting of fungicides, insecticides, nematicides, herbicide and/or safener or growth regulator, preferably from the group consisting of fungicides, insecticides or nematicides, most preferably from the group consisting of insecticides and nematicides. The skilled artisan is familiar with such pesticides, which can be, for example, found in the Pesticide Manual, 13th Ed. (2003), The British Crop Protection Council, London.

The following list of pesticides is intended to illustrate the possible combinations, but not to impose any limitation:

The insecticide/nematicide is preferably selected from the group consisting of A1 to A15:

A1. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
A2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
A3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin;
A4. Growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, a tetronic acid derivative of formula Γ¹,

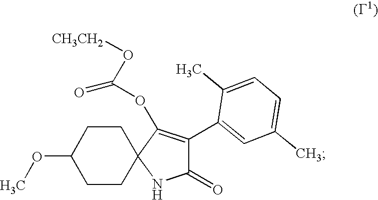

A5. Nicotinic receptor agonists/antagonists compounds: clothianidin, dinotefuran, imidacloprid, thiamethoxam, nitenpyram, acetamiprid, thiacloprid;
A6. GABA antagonist compounds: acetoprole, endosulfan, ethiprole, fipronil, vaniliprole;
A7. Macrocyclic lactone insecticides: abamectin, emamectin, milbemectin, lepimectin, spinosad;
A8. METI (mitochondrial electron transport inhibitor) I acaricides: fenazaquin, pyridaben, tebufenpyrad, tolfenpyrad;
A9. METI II and III compounds: acequinocyl, fluacyprim, hydramethylnon;
A10. Uncoupler compounds: chlorfenapyr;
A11. Oxidative phosphorylation inhibitor compounds: cyhexatin, diafenthiuron, fenbutatin oxide, propargite;
A12. Moulting disruptor compounds: cryomazine;
A13. Mixed Function Oxidase inhibitor compounds: piperonyl butoxide;
A14. Sodium channel blocker compounds: indoxacarb, metaflumizone;
A15. Various: benclothiaz, bifenazate, cartap, flonicamid, pyridalyl, pymetrozine, sulfur, thiocyclam and the aminoisothiazole compounds of formula Γ²,

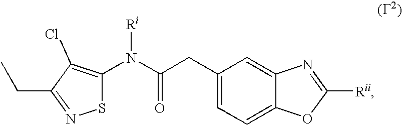

wherein Rⁱ is —CH₂OCH₂CH₃ or H and Rⁱⁱ is CF₂CF₂CF₃ or CH₂CH(CH₃)₃, anthranilamide compounds of formula Γ³

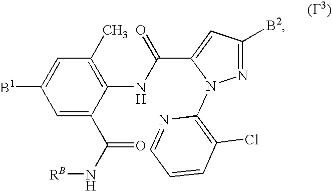

wherein B¹ is hydrogen or a chlorine atom, B² is a bromine atom or CF₃, and R^{B} is CH₃ or CH(CH₃)₂, and malononitrile compounds as described in JP 2002 284608, WO 02/89579, WO 02/90320, WO 02/90321, WO 04/06677, WO 04/20399, or JP 2004 99597

The fungicide can preferably be selected from the group consisting of B1 to B6:

B1. Strobilurins such as azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, methyl 2-(ortho-((2,5-dimethylphenyloxymethylene)phenyl)-3-methoxyacrylate;
B2. Carboxamides such as
carboxanilides: benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(2-cyanophenyl)-3,4-dichloroisothiazole-5-carboxamide;
carboxylic acid morpholides: dimethomorph, flumorph;
benzamides: flumetover, fluopicolide (picobenzamid), zoxamide;
other carboxamides: carpropamid, diclocymet, mandipropamid, N-(2-(4-[3-(4-chlorophenyl)prop-2-ynyloxy]-3-methoxyphenyl)ethyl)-2-methanesulfonylamino-3-methylbutyramide, N-(2-(4-[3-(4-chlorophenyl)prop-2-ynyloxy]-3-methoxyphenyl)ethyl)-2-ethanesulfonylamino-3-methylbutyramide;
B3. Azoles such as
triazoles: bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole;
imidazoles: cyazofamid, imazalil, pefurazoate, prochloraz, triflumizole;
benzimidazoles: benomyl, carbendazim, fuberidazole, thiabendazole;
others: ethaboxam, etridiazole, hymexazole;
B4. Nitrogenous heterocyclyl compounds such as
pyridines: fluazinam, pyrifenox, 3-[5-(4-chlorophenyl)-2,3-dimethylisoxazolidin-3-yl]-pyridine;
pyrimidines: bupirimate, cyprodinil, ferimzone, fenarimol, mepanipyrim, nuarimol, pyrimethanil;
piperazines: triforine;
pyrroles: fludioxonil, fenpiclonil;
morpholines: aldimorph, dodemorph, fenpropimorph, tridemorph;
dicarboximides: iprodione, procymidone, vinclozolin;
others: acibenzolar-5-methyl, anilazine, captan, captafol, dazomet, diclomezine, fenoxanil, folpet, fenpropidin, famoxadone, fenamidone, octhilinone, probenazole, proquinazid, pyroquilon, quinoxyfen, tricyclazole, 5-chloro-7-(4-methylpiperidin-1-yl)-6-(2,4,6-trifluorophenyl)-[1,2,4]triazolo[1,5-a]pyrimidine, 2-butoxy-6-iodo-3-propyl-chromen-4-one, N,N-dimethyl-3-(3-bromo-6-fluoro-2-methylindole-1-sulfonyl)-[1,2,4]triazole-1-sulfonamide;
B5. Carbamates and dithiocarbamates such as
dithiocarbamates: ferbam, mancozeb, maneb, metiram, metam, propineb, thiram, zineb, ziram;
carbamates: diethofencarb, flubenthiavalicarb, iprovalicarb, propamocarb, methyl 3-(4-chlorophenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;
B6. Other fungicides such as
guanidines: dodine, iminoctadine, guazatine;
antibiotics: kasugamycin, polyoxins, streptomycin, validamycin A;
organometallic compounds: fentin salts;
sulfur-containing heterocyclyl compounds: isoprothiolane, dithianon;
organophosphorus compounds: edifenphos, fosetyl, fosetyl-aluminum, iprobenfos, pyrazophos, tolclofos-methyl, phosphorous acid and its salts;
organochlorine compounds: thiophanate-methyl, chlorothalonil, dichlofluanid, tolylfluanid, flusulfamide, phthalide, hexachlorbenzene, pencycuron, quintozene;
nitrophenyl derivatives: binapacryl, dinocap, dinobuton;
inorganic active compounds: Bordeaux mixture, copper acetate, copper hydroxide, copper oxychloride, basic copper sulfate, sulfur;
others: spiroxamine, cyflufenamid, cymoxanil, metrafenone.

The herbicide is preferably selected from the group consisting of C1 to C15:

C1. lipid biosynthesis inhibitors such as chlorazifop, clodinafop, clofop, cyhalofop, diclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloate, diallate, dimepiperate, EPTC, esprocarb, ethiolate, isopolinate, methiobencarb, molinate, orbencarb, pebulate, prosulfocarb, sulfallate, thiobencarb, tiocarbazil, triallate, vernolate, benfuresate, ethofumesate and bensulide;
C2. ALS inhibitors such as amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac;
C3. photosynthesis inhibitors such as atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthylazine, terbutryne, trietazine, ametridione, amibuzin, hexazinone, isomethiozin, metamitron, metribuzin, bromacil, isocil, lenacil, terbacil, brompyrazon, chloridazon, dimidazon, desmedipham, phenisopham, phenmedipham, phenmedipham-ethyl, benzthiazuron, buthiuron, ethidimuron, isouron, methabenzthiazuron, monoisouron, tebuthiuron, thiazafluoron, anisuron, buturon, chlorbromuron, chloreturon, chlorotoluron, chloroxuron, difenoxuron, dimefuron, diuron, fenuron, fluometuron, fluothiuron, isoproturon, linuron, methiuron, metobenzuron, metobromuron, metoxuron, monolinuron, monuron, neburon, parafluoron, phenobenzuron, siduron, tetrafluoron, thidiazuron, cyperquat, diethamquat, difenzoquat, diquat, morfamquat, paraquat, bromobonil, bromoxynil, chloroxynil, iodobonil, ioxynil, amicarbazone, bromofenoxim, flumezin, methazole, bentazone, propanil, pentanochlor, pyridate, and pyridafol;
C4. protoporphyrinogen-IX oxidase inhibitors such as acifluorfen, bifenox, chlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen and etnipromid;
C5. bleacher herbicides such as metflurazon, norflurazon, flufenican, diflufenican, picolinafen, beflubutamid, fluridone, fluorochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethylphenoxy)-2-(4-trifluoromethylphenyl)pyrimidine, and also 3-heterocyclyl-substituted benzoyl derivatives of the following formula (see in WO 96/26202, WO 97/41116, WO 97/41117 and WO 97/41118):

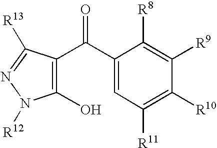

in which the variables R⁸ to R¹³ are as defined below:
R⁸, R¹⁰ are hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-alkylsulfinyl or C₁-C₆-alkylsulfonyl;
R⁹ is a heterocyclic radical selected from the group consisting of such as thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, where the nine radicals mentioned may be unsubstituted or mono- or polysubstituted, e.g. mono-, di-, tri- or tetrasubstituted, by halogen, C₁-C₄-alkyl, C₁-C₄-alkoxy, C₁-C₄-haloalkyl, C₁-C₄-haloalkoxy or C₁-C₄-alkylthio;
R¹¹ is hydrogen, halogen or C₁-C₆-alkyl;
R¹² is C₁-C₆-alkyl;
R¹³ is hydrogen or C₁-C₆-alkyl.
C6. EPSP synthase inhibitors such as glyphosate;
C7. glutamine synthase inhibitors such as glufosinate and bilanaphos;
C8. DHP synthase inhibitors such as asulam;
C9. mitose inhibitors such as benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, tebutam, chlorthal, carbetamide, chlorbufam, chlorpropham and propham;
C10. VLCFA inhibitors such as acetochlor, alachlor, butachlor, butenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphane;
C11. cellulose biosynthesis inhibitors such as dichlobenil, chlorthiamid, isoxaben and flupoxam;
C12. decoupler herbicides such as dinofenate, dinoprop, dinosam, dinoseb, dinoterb, DNOC, etinofen and medinoterb;
C13. auxin herbicides such as clomeprop, 2,4-D, 2,4,5-T, MCPA, MCPA thioethyl, dichlorprop, dichlorprop-P, mecoprop, mecoprop-P, 2,4-DB, MCPB, chloramben, dicamba, 2,3,6-TBA, tricamba, quinclorac, quinmerac, clopyralid, fluoroxypyr, picloram, triclopyr and benazolin;
C14. auxin transport inhibitors such as naptalam, diflufenzopyr;
C15. benzoylprop, flamprop, flamprop-M, bromobutide, chlorflurenol, cinmethylin, methyldymron, etobenzanid, fosamine, metam, pyributicarb, oxaziclomefone, dazomet, triaziflam and methyl bromide.

The term safener has the following meaning: It is known that in some cases better crop plant compatibility can be achieved by joint application of specifically acting herbicides with organic active compounds, some of which are themselves herbicidally active. In these cases, the active compounds act as antidote or antagonist, and, owing to the fact that they can reduce or even prevent damage to the crop plants, they are also referred to as safeners.

Suitable safeners can be preferably selected from the following listing: benoxacor, cloquintocet, cyometrinil, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro[4.5]decane (AD-67; MON 4660) and oxabetrinil.

The following list of groth regulaters identifies possible active ingredients, but is not intended to be limited thereto:

1-naphthylacetamide, 1-naphthylacetic acid, 2-naphthyloxyacetic acid, 3-CPA (cloprop), 4-CPA (4-chlorophenoxyacetic acid), ancymidol, anthraquinone, BAP (6-benzylaminopurine), butifos; tribufos, butralin, chlorflurenol, chlormequat, clofencet, cyclanilide, daminozide, dicamba, dikegulac-sodium, dimethipin, chlorfenethol, etacelasil, ethephon, ethychlozate, fenoprop, 2,4,5-TP (fenoprop), fluoridamid, flurprimidol, flutriafol, gibberellic acid, gibberellin, guazatine, indolylbutyric acid, indolylacetic acid, karetazan, kinetin, lactidichlor-ethyl, maleic hydrazide, mefluidide, mepiquat-chloride, naptalam, paclobutrazole, prohexadione-calcium, quinmerac, sintofen, tetcyclacis, thidiazuron, triiodobenzoic acid, triapenthenol, triazethan, tribufos, trinexapac-ethyl, uniconazole.

Preferred insecticides are flufenoxuron, fipronil, alphacypermethrin, cypermethrin, chlorfenapyr, teflubenzuron, terbufos, dimethoate, fenbutatin oxide, imidachlorpid, chlorpyrifos, thiametoxan, deltamethrin, lambda cyhalotrin, indoxacarb, spinosad, abamectin, bifenthrin, endosulfan, aldicarb, methomyl, carbofuran, wherein flufenoxuron, fipronil, alphacypermethrin, cypermethrin, chlorfenapyr, teflubenzuron, terbufos, dimethoate, fenbutatin oxide, imidachlorpid, chlorpyrifos, thiametoxan, deltamethrin, lambda cyhalotrin, indoxacarb, spinosad, abamectin, bifenthrin, endosulfan, aldicarb, methomyl, carbofuran more preferred and flufenoxuron is most preferred.

Preferred fungicides are epoxiconazole, pyraclostrobin, kresoxim-methyl, carbendazim, metrafenone, boscalid, triticonazole, metconazole, dimethomorph, fenpropimorph, prochloraz, vinclozolin, iprodione, ditianon, metiram, tebuconazole, azoxystrobin, mancozeb, trifloxystrobin, chlorothalonil, metalaxyl, fosetyl, difemoconazole, cyprodinil, spiroxamine, prothioconazole, picoxystrobin.

As mentioned above, also mixtures of pesticides are preferred. For example, the following mixtures are preferred:

the mixture of alphacypermethrin and acetamiprid;
the mixture of fipronil and imidacloprid;
the mixture of fipronil and acetamiprid;
the mixture of fipronil and acephate;
the mixture of fipronil and thiametoxan;
the mixture of fipronil and pymetrozine;
the mixture of fipronil and alphacypermethrin;
the mixture of metaflumizone and acetamiprid;
the mixture of metaflumizone and teflubenzuron;
the mixture of alphacypermethrin and chlorpyrifos; and
the mixture of metaflumizone and flufenoxuron.

Preferred are mixtures of at least two pesticides, preferably consisting of two pesticides, wherein one pesticide has a solubility in water at 25° C. being two times higher, preferably ten times higher, more preferably hundred times higher, even more preferably thousand times higher, yet even more preferably hundred thousand times higher, and most preferably one million times higher compared to another pesticide within the mixture. The terms “solubility being ten times higher” and respective terms mean that for example one compound has a solubility of 1 mg/l and the other has a solubility of 10 mg/l in water at 25° C.

More preferred are mixtures of at least two pesticides, preferably consisting of two pesticides, wherein one pesticide has a solubility in water at 25° C. of less than 5 mg/l, preferably less than 3 mg/l and more preferably less than 0.1 mg/l, and another pesticide has a solubility of more than 200 mg/l, preferably more than 500 mg/l and most preferably more than 2000 mg/l.

Most preferred are mixtures of at least two pesticides, preferably consisting of two pesticides, wherein one pesticide has a solubility in water at 25° within a range of 0.0001 mg/l to 5 mg/l, preferably 0.0005 to 3 mg/l and more preferably 0.001 to 0.1, and another pesticide within the range of 200 mg/l to 1,000,000 mg/l, preferably 500 to 800,000 mg/l, more preferably 2000 to 10,000 mg/l.

Most preferred examples are

the mixture of alphacypermethrin and acetamiprid;
the mixture of fipronil and imidacloprid
the mixture of fipronil and acetamiprid;
the mixture of fipronil and acephate;
the mixture of fipronil and thiametoxan;
the mixture of fipronil and pymetrozine;
the mixture of fipronil and alphacypermethrin;
the mixture of metaflumizone and acetamiprid;
the mixture of metaflumizone and teflubenzuron;
the mixture of alphacypermethrin (0.004) and chlorpyrifos; and
the mixture of metaflumizone and flufenoxuron.

Among these mixtures the mixture of alphacypermethrin and acetamiprid is especially preferred.

In a further embodiment, the formulation additionally comprises a non-ionic surfactant d). Examples of suitable non-ionic surfactants are include but are not limited to alkoxy units comprising copolymers, e.g. block copolymers (e.g EO or PO or EO/PO copolymers), ethoxylated or propoxylated or ethoxylated and propoxylated alcohols, of which long chain alcohols are preferred, ethoxylated or propoxylated or ethoxylated and propoxylated alkyl phenols, ethoxylated or propoxylated or ethoxylated and propoxylated fatty acids, fatty esters, glycerol esters and derivatives, lanolin based derivatives, sorbitan derivatives, sucrose esters and derivatives, siloxanes, glycol esters and derivatives. Preferred are non-ionic surfactants are long chain alcohol ethoxylates and EO/PO block copolymers.

Optionally, the formulation may comprise also further formulation auxiliaries e) suitable for the formulation of agrochemicals, such as additional surfactants, antifoaming agents, anti-freezing agents, stabilizers and/or antioxidants, optionally if the formulation is intended for seed treatment purposes dyes and binders.

Suitable stabilizers are, for example carboxylic acids (citric acid, acetic acid, dodecylbenzensulfonic acid), orthophosphoric acid dodecylbenzensulfonic acid and suitable salts thereof. Suitable antioxidants are for example butylhydroxytoluene.

Suitable antifreeze agents are for example glycerine, ethylene glycol, hexyleneglycol, propylene glycol.

Suitable antifoaming agents are for example antifoaming agents based on modified silicon, for example Polydimethylsiloxanes.

Suitable stickers/binders for seed treatment formulations are block copolymers EO/PO surfactants but also polyvinylalcohols, polyvinylpyrrolidones, polyacrylates, polymethacrylates, polybutenes, polyisobutylenes, polystyrene, polyethyleneamines, polyethyleneamides, polyethyleneimines (Lupasol®, Polymin®), polyethers, polyurethans, polyvinylacetate, tylose and copolymers derived from these polymers.

Suitable dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108. They must be soluble in solvents.

In case such auxiliaries are used they may be employed in amounts known to the artisan from the literature.

The total amount of pesticide a) is from 0.1% up to 50% by weight, preferably from 1% to 20% by weight.

The amount of organic solvent b) is from 30% up to 99.8% by weight, preferably from 50% to 80% by weight.

The amount of the mixture comprising a non-ionic distyrylphenol alkoxylate and a ionic distyrylphenol alkoxylate c) is from 0.1% up to 30% by weight, preferably from 0.7% to 20% by weight and most preferably from 1.5 to 10 wt %.

The ratio of ionic distyrylphenol alkoxylate to non ionic distyrylphenol alkoxylate can vary in broad ranges, preferably in ranges from 90/10 to 20/80 by weight.

The amount of non-ionic surfactant d) is from 0% up to 50% by weight, preferably 0.1% up to 50% by weight, most preferably from 5% to 15% by weight in respect to the total weight of compounds a) to c).

The % by weight data of the individual components add up to 100% by weight.

Preferred formulations of this invention comprise
a) 0.1-50 wt % of at least one pesticide,
b) 30-99.8% of at least one organic solvent,
c) 0.1-50 wt % of a mixture comprising a non-ionic distyrylphenol alkoxylate and a ionic distyrylphenol alkoxylate,
d) 0-50 wt % non-ionic surfactant, and
e) 0-20 wt % further formulation auxiliaries.

The organic solvent b) in these formulations is preferably a mixture of organic solvents.

A preferred mixture comprises 30-70 wt % lactone and 30-70 wt % sulfoxide, or 5-40 wt % lactone and 5-45 wt % alcohol and 40-80 wt % sulfoxide, based on the total weight of the mixture of organic solvents.

More preferred are mixtures comprising 30-70 wt % γ-butyrolactone and 30-70 wt % dimethylsulfoxide; or 5-40 wt % γ-butyrolactone and 5-45 wt % benzylalcohol and 40-80 wt % dimethylsulfoxide, based on the total weight of the mixture of organic solvents.

Most preferred are mixtures comprising 40-60 wt % γ-butyrolactone and 40-60 wt % dimethylsulfoxide; or 10-30 wt % γ-butyrolactone and 15-35 wt % benzylalcohol and 50-70 wt % dimethylsulfoxide, based on the total weight of the mixture of organic solvents.

Compositions comprising at least two pesticides are most preferred.

The preferred formulations comprise
a) 0.1-50 wt % of at least two pesticides,
b) 30-99.8 wt % of at least two polar organic solvents,
c) 0.1-50 wt % of a mixture comprising a non-ionic distyrylphenol alkoxylate and a ionic distyrylphenol alkoxylate,
d) 0-50 wt % non-ionic surfactant, and
e) 0-20 wt % further formulation auxiliaries.

The more preferred formulations comprise
a) 0.1-50 wt % of at least two pesticides comprising
   alphacypermethrin and acetamiprid; or
   fipronil and imidacloprid; or
   fipronil and acetamiprid; or
   fipronil and acephate; or
   fipronil and thiametoxan; or
   fipronil and pymetrozine; or
   fipronil and alphacypermethrin; or
   metaflumizone and acetamiprid; or
   metaflumizone and teflubenzuron; or
   alphacypermethrin and chlorpyrifos; or
   metaflumizone and flufenoxuron,
b) 30-99.8 wt % of at least two polar organic solvents,
c) 0.1-50 wt % of a mixture comprising a non-ionic distyrylphenol alkoxylate and a ionic distyrylphenol alkoxylate,
d) 0-50 wt % non-ionic surfactant, and
e) 0-20 wt % further formulation auxiliaries.

The even more preferred formulations comprise
a) 0.1-50 wt % of at least two pesticides comprising
   alphacypermethrin and acetamiprid; or
   fipronil and imidacloprid; or
   fipronil and acetamiprid; or
   fipronil and acephate; or
   fipronil and thiametoxan; or
   fipronil and pymetrozine; or
   fipronil and alphacypermethrin; or
   metaflumizone and acetamiprid; or
   metaflumizone and teflubenzuron; or
   alphacypermethrin and chlorpyrifos; or
   metaflumizone and flufenoxuron,
b) 30-99.8 wt % of at least two polar organic solvents,
c) 0.1-50 wt % of a mixture of distyrylphenol alkoxylate and sulfated or phosphonated distyrylphenol alkoxylate salt,
d) 0-50 wt % non-ionic surfactant, and
e) 0-20 wt % further formulation auxiliaries.

The most preferred formulations comprise
a) 0.1-50 wt % of at least two pesticides comprising
   alphacypermethrin and acetamiprid; or
   fipronil and imidacloprid; or
   fipronil and acetamiprid; or
   fipronil and acephate; or
   fipronil and thiametoxan; or
   fipronil and pymetrozine; or
   fipronil and alphacypermethrin; or
   metaflumizone and acetamiprid; or
   metaflumizone and teflubenzuron; or
   alphacypermethrin and chlorpyrifos; or
   metaflumizone and flufenoxuron.
b1) 5-50 wt % lactone,
b2) 5-50 wt % alcohol,
b3) 10-80 wt % sulfoxide,
c) 0.1-30 wt % mixture of distyrylphenol alkoxylate and sulfated or phosphonated distyrylphenol alkoxylate salt,
d) 0-50 wt % non-ionic surfactant, and
e) 0-20 wt % further formulation auxiliaries.

Formulations comprising alphacypermethrin and acetamiprid are most preferred.

The preferred formulations comprise
a1) 0.1-50 wt % alpha-cypermethrin,
a2) 0.1-50 wt % acetamiprid,
b) 5-80 wt % of at least two polar organic solvents,
c) 0.1-30 wt % of a mixture of distyrylphenol alkoxylate and sulfated distyrylphenol alkoxylate ammonium salt,
d) 0-50 wt % non-ionic surfactant, and
e) 0-20 wt % further formulation auxiliaries.

The most preferred formulations comprise
a1) 0.1-50 wt % alpha-cypermethrin,
a2) 0.1-50 wt % acetamiprid,
b1) 5-50 wt % lactone,
b2) 5-50 wt % alcohol,
b3) 10-80 wt % sulfoxide,
c) 0.1-30 wt % of a mixture of distyrylphenol ethoxylate and sulfated distyrylphenol ethoxylate ammonium salt,
d) 0-50 wt % non-ionic surfactant, and
e) 0-20 wt % further formulation auxiliaries.

The especially preferred formulations comprise
a1) 0.1-50 wt % alpha-cypermethrin,
a2) 0.1-50 wt % acetamiprid,
b1) 5-50 wt % γ-butyrolactone,
b2) 5-50 wt % benzyl alcohol,
b3) 10-80 wt % dimethylsulfoxide,
c) 0.1-30 wt % of a mixture of distyrylphenol ethoxylate and sulfated distyrylphenol ethoxylate ammonium salt,
d) 0-50 wt % non-ionic surfactant comprising a EO/PO block polymer, and
e) 0-20 wt % further formulation auxiliaries comprising dodecylbenzoic acid.

The most preferred formulations comprise
a1) 1-7 wt % alpha-cypermethrin,
a2) 4-15 wt % acetamiprid,
b1) 10-20 wt % γ-butyrolactone,
b2) 12-23 wt % benzyl alcohol,
b3) 35-50 wt % dimethylsulfoxide,
c) 1-7 wt % of a mixture of distyrylphenol ethoxylate and sulfated distyrylphenol ethoxylate ammonium salt,
d) 0-50 wt % non-ionic surfactant comprising a EO/PO block polymer, and
e) 0-20 wt % further formulation auxiliaries comprising dodecylbenzoic acid.

The formulations can be prepared in a known manner (see e.g. for review U.S. Pat. No. 3,060,084, EP-A 707 445 (for liquid concentrates), Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the pesticide with the solvent as defined above and an emulsifier according to the present invention and optionally further surfactant(s) and formulation auxiliaries as defined above.

For example, the formulation can be a solution for seed treatment (LS), a dispersible concentrate (DC) or emulsifiable concentrate (EC) formulation. LS formulation are especially suitable for seed treatment. For seed treatment purposes, such formulation may also applied undiluted or diluted to the seeds.

The present invention furthermore relates to a method of combating harmful insects and/or phytopathogenic fungi, which comprises contacting said harmful insects and/or phytopathogenic fungi, their habit, breeding ground, food supply, plant, seed, soil, area, material or environment in which the harmful insects and/or phytopathogenic fungi are growing or may grow, or the materials, plants, seeds, soils, surfaces or spaces to be protected from attack or infestation by said harmful insects and/or phytopathogenic fungi with an effective amount of a agrochemical formulation according to the present invention.

The present invention furthermore relates to a method of controlling undesired vegetation and/or a method of growth regulation of plants, which comprises allowing a herbicidally or growth regulatory effective amount of a agrochemical formulation according to the present invention to act on plants, their habitat or on seed of said plants.

The term phytopathogenic fungi includes but is not limited to the following species:

Alternaria spp. on rice, vegetables, soybeans, canola/oilseed rape and sugarbeet and fruit
Aphanomyces spp. on sugarbeet and vegetables Bipolaris and Drechslera spp. on corn, cereals, rice and turf, Blumeria graminis (powdery mildew) on cereals, Botrytis cinerea (gray mold) on strawberries, vegetables, ornamentals and grapevines, Bremia lactucae on lettuce Cercospora spp. on corn, soyabeans and sugarbeet Cochliobolus spp. on corn, cereals on rice (e.g. Cochliobolus sativus on cereals, Cochliobolus miyabeanus on rice) Colletotrichum spp. on soybeans and cotton Drechslera spp. on cereals and corn Exserohilum spp. on corn Erysiphe cichoracearum and Sphaerotheca fuliginea on cucurbits, Erysiphe necator on grapevines Fusarium and Verticillium spp. on various plants, Gaeumannomyces graminis on cereals Gibberella spp. on cereals and rice (e.g. Gibberella fujikuroi on rice, Gibberella zeae on cereals) Grainstaining complex on rice Microdochium nivale on cereals Mycosphaerella spp. on cereals, bananas and peanuts, Phakopsora pachyrhizi and Phakopsora meibomiae on soybeans Phomopsis spp. on soybeans and sunflower Phytophthora infestans on potatoes and tomatoes, Plasmopara viticola on grapevines, Podosphaera leucotricha on apples, Pseudocercosporella herpotrichoides on wheat and barley, Pseudoperonospora spp. on hops and cucumbers, Puccinia spp. on cereals and corn, Pyrenophora spp. on cereals Pyricularia oryzae on rice, Cochliobolus miyabeanus and Corticium sasakii (Rhizoctonia solani), Fusarium semitectum (and/or moniliforme), Cercospora oryzae, Sarocladium oryzae, S. attenuatum, Entyloma oryzae, Gibberella fujikuroi (bakanae), Grainstaining complex (various pathogens), Bipolaris spp., Drechslera spp. and Pythium and Rhizoctonia spp. on rice, corn, cotton, canola, oilseed rape, sunflower, sugarbeet, vegetables, turf, nuts and other various plants Rhizoctonia solani on potato Sclerotinia spp. on canola/oilseed rape and sunflower Septoria tritici and Stagonospora nodorum on wheat, Uncinula necator on grapevines, Sphacelotheca reiliana on corn Thievaliopsis spp. on soybeans and cotton Tilletia spp. on cereals Ustilago spp. on cereals corn, and sugar cane, and Venturia spp. (scab) on apples and pears;

The term harmful insect pests includes but is not limited to the following arthropods and nematodes:

Millipedes (Diplopoda) such as Blaniulus species
Ants (Hymenoptera), such as. Atta capiguara, Atta cephalotes, Atta laevigata, Atta robusta, Atta sexdens, Atta texana, Monomorium pharaonis, Solenopsis geminata, Solenopsis invicta, Pogonomyrmex species and Pheidole megacephala,
Beetles (Coleoptera), such as Agrilus sinuatus, Agriotes lineatus, Agriotes obscurus and other Agriotes species, Amphimallus solstitialis, Anisandrus dispar, Anthonomus grandis, Anthonomus pomorum, Aracanthus morei, Atomaria linearis, Blapstinus species, Blastophagus piniperda, Blitophaga undata, Bothynoderes punciventris, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus and other Conoderus species, Conorhynchus mendicus, Crioceris asparagi, Cylindrocopturus adspersus, Diabrotica (longicornis) barberi, Diabrotica semi-punctata, Diabrotica speciosa, Diabrotica undecimpunctata, Diabrotica virgifera and other Diabrotica species, Eleodes species, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus and other Limonius species, Lissorhoptrus oryzophilus, Listronotus bonariensis, Melanotus communis and other Melanotus species, Meligethes aeneus, Melolontha hippocastani, Melolontha melolontha, Oulema oryzae, Ortiorrhynchus sulcatus, Oryzophagus oryzae, Otiorrhynchus ovatus, Oulema oryzae, Phaedon cochleariae, Phyllotreta chrysocephala, Phyllophaga cuyabana and other Phyllophaga species, Phyllopertha horticola, Phyllotreta nemorum, Phyllotreta striolata, and other Phyllotreta species, Popillia japonica, Promecops carinicollis, Premnotrypes voraz, Psylliodes species, Sitona lineatus, Sitophilus granaria, Sternechus pinguis, Sternechus subsignatus, and Tanymechus palliatus and other Tanymechus species,
Flies (Diptera) such as Agromyza oryzea, Chrysomya bezziana, Chrysomya hominivorax, Chrysomya macellaria, Contarinia sorghicola, Cordylobia anthropophaga, Dacus cucurbitae, Dacus oleae, Dasineura brassicae, Delia antique, Delia coarctata, Delia platura, Delia radicum, Fannia canicularis, Gasterophilus intestinalis, Geomyza Tripunctata, Glossina morsitans, Haematobia irritans, Haplodiplosis equestris, Hypoderma lineata, Liriomyza sativae, Liriomyza trifolii, Lucilia caprina, Lucilia cuprina, Lucilia sericata, Lycoria pectoralis, Mayetiola destructor, Muscina stabulans, Oestrus ovis, Opomyza florum, Oscinella frit, Pegomya hysocyami, Phorbia antiqua, Phorbia brassicae, Phorbia coarctata, Progonya leyoscianii, Psila rosae, Rhagoletis cerasi, Rhagoletis pomonella, Tabanus bovinus, Tetanops myopaeformis, Tipula oleracea and Tipula paludosa,
Heteropterans (Heteroptera), such as Acrosternum hilare, Blissus leucopterus, Cicadellidae such as Empoasca fabae, Chrysomelidae, Cyrtopeltis notatus, Delpahcidae, Dysdercus cingulatus, Dysdercus intermedius, Eurygaster integriceps, Euschistus impictiventris, Leptoglossus phyllopus, Lygus lineolaris, Lygus pratensis, Nephotettix species, Nezara viridula, Pentatomidae, Piesma quadrata, Solubea insularis and Thyanta perditor,
Aphids and other homopterans (Homoptera), e.g. Acyrthosiphon onobrychis, Adelges laricis, Aphidula nasturtii, Aphis fabae, Aphis forbesi, Aphis glycines, Aphis gossypii, Aphis grossulariae, Aphis pomi, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes (Myzus) persicae, Myzus ascalonicus, Myzus cerasi, Myzus varians, Nasonovia ribis-nigri, Nilaparvata lugens, Pemphigus bursarius, Pemphigus populivenae, and other Pemphigus species, Perkinsiella saccharicida, Phorodon humuli, Psyllidae such as Psylla mali, Psylla piri and other Psylla species, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii;
Lepidopterans (Lepidoptera), for example Agrotis ypsilon, Agrotis segetum and other Agrotis species, Alabama argillacea, Anticarsia gemmatalis, Argyresthia conjugella, Autographa gamma, Bupalus piniarius, Cacoecia murinana, Capua reticulana, Chematobia brumata, Chilo suppresalis and other Chilo species, Choristoneura fumiferana, Choristoneura occidentalis, Cirphis unipuncta, Cnaphlocrocis medinalis, Cydia pomonella, Dendrolimus pini, Diaphania nitidalis, Diatraea grandiosella, Earias insulana, Elasmopalpus lignosellus, Eupoecilia ambiguella, Euxoa species, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Lerodea eufala, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Momphidae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sesamia nonagrioides and other Sesamia species, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,
orthopterans (Orthoptera), such as Acrididae, Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus;
termites (Isoptera), such as Calotermes flavicollis, Coptotermes species, Dalbulus maidis, Leucotermes flavipes, Macrotermes gilvus, Reticulitermes lucifugus and Termes natalensis;
thrips (Thysanoptera) such as Frankliniella fusca, Frankliniella occidentalis, Frankliniella tritici and other Frankliniella species, Scirtothrips citri, Thrips oryzae, Thrips palmi, Thrips simplex and Thrips tabaci,
Arachnoidea, such as arachnids (Acarina), for example e.g. of the families Argasidae, Ixodidae and Sarcoptidae, such as Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae species such as Aculus schlechtendali, Phyllocoptrata oleivora and Eriophyes sheldoni; Tarsonemidae species such as Phytonemus pallidus and Polyphagotarsonemus latus; Tenuipalpidae species such as Brevipalpus phoenicis; Tetranychidae species such as Tetranychus cinnabarinus, Tetranychus kanzawai, Tetranychus pacificus, Tetranychus telarius and Tetranychus urticae, Panonychus ulmi, Panonychus citri, and Oligonychus pratensis;
Nematodes, especially plant parasitic nematodes such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species; Sting nematodes, Belonolaimus longicaudatus and other Belonolaimus species; Pine nematodes, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Lesion nematodes, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species; Dagger nematodes, Xiphinema species; and other plant parasitic nematode species.

The control of undesired vegetation is understood as meaning the destruction of weeds. Weeds, in the broadest sense, are understood as meaning all those plants which grow in locations where they are undesired.

As mentioned above, in one embodiment of the methods of combating harmful fungi and/or insects, the formulation according to the invention can be used also for the treatment of seeds from plants.

The present invention also comprises seeds coated with formulation according to the present invention.

The term seed embraces seeds and plant propagules of all kinds including but not limited to true seeds, seed pieces, suckers, corms, bulbs, fruit, tubers, grains, cuttings, cut shoots and the like and means in a preferred embodiment true seeds.

Suitable seed is seed of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

In addition, the formulation according to the invention may also be used for the treatment seeds from plants, which tolerate the action of herbicides or fungicides or insecticides owing to breeding, including genetic engineering methods, for example seeds of transgenic crops which are resistant to herbicides from the group consisting of the sulfonylureas (EP-A-0257993, U.S. Pat. No. 5,013,659), imidazolinones (see for example U.S. Pat. No. 6,222,100, WO0182685, WO0026390, WO9741218, WO9802526, WO9802527, WO 04/106529, WO 05/20673, WO 03/14357, WO 03/13225, WO 03/14356, WO 04/16073), glufosinate-type (see for example EP-A-0242236, EP-A-242246) or glyphosate-type (see for example WO 92/00377) or in seeds of plants resistant towards herbicides selected from the group of cyclohexadienone/Aryloxyphenoxypropionic acid herbicides (U.S. Pat. No. 5,162,602, U.S. Pat. No. 5,290,696, U.S. Pat. No. 5,498,544, U.S. Pat. No. 5,428,001, U.S. Pat. No. 6,069,298, U.S. Pat. No. 6,268,550, U.S. Pat. No. 6,146,867, U.S. Pat. No. 6,222,099, U.S. Pat. No. 6,414,222) or in seeds of transgenic crop plants, for example cotton, with the capability of producing Bacillus thuringiensis toxins (Bt toxins) which make the plants resistant to certain pests (EP-A-0142924, EP-A-0193259).

The seed treatment application of the formulation according to the invention is carried out by spraying or dusting the seeds before sowing of the plants and before emergence of the plants by methods known to the skilled artisan.

In the treatment of seeds the corresponding formulations are applied by treating the seeds with an effective amount of the formulation according to the present invention. Herein, the application rates of pesticide are generally from 0.1 g to 10 kg per 100 kg of seed, preferably from 1 g to 5 kg per 100 kg of seed, in particular from 1 g to 2.5 kg per 100 kg of seed. For specific crops such as lettuce or onion, the rate can be higher.

### EXAMPLES

Soprophor DSS/15 (Rhodia): ammonium salt of ethoxylated polyarylphenol sulfate, CAS No. 59891-11-1 (corresponds to Poly(oxy-1,2-ethanediyl), .alpha.-sulfo-.omega.-[bis(1-phenylethyl)phenoxy]-, ammonium salt). The product contains 25-35 wt % of the corresponding non-ionic, non-sulphonated polyarylphenol ethoxylate.

Soprophor® 4 D 384 (Rhodia): contains >50% ammonium salt of polyarylphenyl ether sulphate, CAS No. 119432-41-6 (corresponds to Poly(oxy-1,2-ethanediyl), alpha.sulfo-.omega.-[2,4,6-tris(1-phenylethyl)phenoxy]-, ammonium salt).

### Example 1

### A—Preparation of Distyrylphenolethoxylate Comprising Formulation (Formulation No. 1)—1 L Total Volume

To 50 g flufenoxuron 400 g of γ-butyrolactone and 449 g dimethylsulfoxide as solvents were added. The resulting mixture was stirred until flufenoxuron was completely solved. Afterwards, citric acid monohydrate and butylhydroxytoluol were added. After mixing, 60 g commercial available distrylyphenolethoxylate mixture (Soprophor® DSS/15, Rhodia) were added. After solving, an ethoxylated longchain alcohole (Lutensol® TO 3, BASF) was added and thoroughly mixed. Optionally, the mixture was filtrated.

### B—Preparation of Comparative Formulation (Formulation No. 2)—1 L Total Volume

To 50 g flufenoxuron 400 g of γ-butyrolactone and 460 g dimethylsulfoxide were added. The resulting mixture was stirred until flufenoxuron was completely solved. Afterwards, dodecylbenzoic acid (Lutensit® A-LBS, BASF) and butylhydroxytoluol were added. After mixing, 120 g commercial available tristrylyphenolethoxylate (Soprophor® 4 D 384, Rhodia) were added. After solving, a ethoxylated lonchain alcohole (Lutensol® TO 3, BASF) was added and thoroughly mixed. Optionally, the mixture was filtrated.

### Example 2

### Biological Activity

A field was subdivided in treated lots and one lot untreated (UTC=untreated control). Cultures and pests are set forth below in Table 1. The trials were evaluated by estimating the damage done by the formulation (phytotoxicity) by counting or estimating the damage done by the pests and comparing the values with the UTC (eating damage).

Phytotoxicity and eating damage were tested after two treatments. Respective data are summarized in Table 1.

Compared to formulations without Soprophor® DSS/15 a better biological efficacy was observed.

TABLE 1

| | Trial 1 | Trial 2 |
|---|---|---|
| | [% phytotoxicity/ | [% phytotoxicity/ |
| | % eating damage] | % eating damage] |
| Culture | Cabbage | Broccoli |
| Pest | Diamondback Moth | Pieris rapae |
| Formulation No. 1 | 0%/0.5% | 0%/5.4% |
| Formulation No. 2 | 0%/1.3% | 0%/6.5% |

### Example 3

### A—Preparation of Distrylyphenolethoxylate Comprising Formulation (Formulation No. 3)—1 L Total Volume

To 25 g alpha-cypermethrin and 100 g acetamiprid 160 g of γ-butyrolactone as well as 200 g benzyl alcohole and 470 g dimethylsulfoxide were added. The resulting mixture was stirred until the active ingredients were completely solved. Afterwards, dodecylbenzoic acid (Lutensit® A-LBS, BASF) was added. After mixing, 45 g commercial available distrylyphenolethoxylate mixture (Soprophor® DSS/15, Rhodia) were added. After solving, Pluronic® PE 6400 (from BASF, a block copolymer in which the central polypropylene glycol group is flanked by two polyethylene glycol groups, molar mass 2900), was added and thoroughly mixed. Optionally, the mixture was filtrated.

### B—Preparation of Comparative Formulation (Formulation No. 4)—1 L Total Volume

To 25 g alpha-cypermethrin and 100 g acetamiprid 160 g of γ-butyrolactone as well as 200 g benzyl alcohole and 470 g dimethylsulfoxide were added. The resulting mixture was stirred until the active ingredients were completely solved. Afterwards, dodecylbenzoic acid (Lutensit® A-LBS, BASF) was added. After mixing, 120 g commercial available tristrylyphenolethoxylate (Soprophor® 4 D 384, Rhodia) were added. After solving, a block copolymer (Pluronic® PE 6400, BASF) was added and thoroughly mixed. Optionally, the mixture was filtrated.

### Example 4

### Physical Stability after Storage

A standard storage test was carried out with formulations of example 3.

Physical and chemical stability was assessed after two weeks at +54° C.

Compared to the formulation without Soprophor® DSS/15 a better physical stability was assigned.

TABLE 1
physical stability

| | |
|---|---|
| Formulation A | Formulation B |

Initial

| | | |
|---|---|---|
| appearance | clear, yellow liquid | clear, light brown liquid |

after two weeks at +54° C.

| | | |
|---|---|---|
| appearance | clear, yellow liquid | the actives crystallized completely |

1-15. (canceled)

16. A liquid non aqueous formulation comprising
(a) one or more pesticides;
(b) one or more organic solvents; and
(c) a mixture comprising a non-ionic distyrylphenol alkoxylate and an ionic distyrylphenol alkoxylate.

17. The formulation of claim 16, further comprising d) a non-ionic surfactant.

18. The formulation of claim 17, wherein
(a) the amount of the one or more pesticides is from 0.1% up to 50% by weight;
(b) the amount of the one or more organic solvents is from 30% up to 99.8% by weight;
(c) the amount of the mixture comprising the non-ionic distyrylphenol alkoxylate and the ionic distyrylphenol alkoxylate is from 0.1% to 50% by weight; and
(d) the amount of the non-ionic surfactant is from 0% up to 50% by weight. wherein the % by weight of the individual components add up to 100% by weight.

19. The formulation of claim 16, wherein the one or more organic solvents comprise a polar organic solvent.

20. The formulation according to claim 19, wherein the one or more organic solvents comprise one or more compounds selected from the group consisting of lactones, N,N-dialkyl alkylamides, sulfoxides, ketones, alkylene carbonates and alcohols.

21. The formulation of claim 19, wherein the one or more organic solvents comprise
(a) a mixture of at least two compounds selected from N,N-dialkyl alkylamides; or
(b) at least one compound selected from sulfoxides and at least one compound selected from lactones; or
(c) at least one compound selected from sulfoxides, at least one compound selected from lactones and at least one compound selected from alcohols; or
(d) at least one compound selected from lactones, at least one compound selected from alcohols, at least one compound selected from ketones and at least one compound selected from alkylene carbonates.

22. The formulation of claim 21, wherein the one or more organic solvents comprise a mixture of N,N-dimethyl octanamide and N,N-dimethyl decanamide; or a mixture of DMSO and γ-butyrolactone; or a mixture of DMSO, γ-butyrolactone and benzyl alcohol; or a mixture of γ-butyrolactone, benzyl alcohol, acetophenone and propylene carbonate.

23. The formulation of claim 21, wherein the one or more pesticides is mixture of at least two pesticides, wherein one pesticide has a solubility in water at 25° C. being one hundred times higher compared to another pesticide within the mixture.

24. The formulation according to claim 21, wherein the one or more pesticides comprise
a mixture of alphacypermethrin and acetamiprid; or
a mixture of fipronil and imidacloprid; or
a mixture of fipronil and acetamiprid; or
a mixture of fipronil and acephate; or
a mixture of fipronil and thiametoxan; or
a mixture of fipronil and pymetrozine; or
a mixture of fipronil and alphacypermethrin; or
a mixture of metaflumizone and acetamiprid; or
a mixture of metaflumizone and teflubenzuron; or
a mixture of alphacypermethrin and chlorpyrifos; or
a mixture of metaflumizone and flufenoxuron.

26. A method of reducing eye toxicity in an agrochemical formulation comprising at least one organic solvent comprising using a mixture comprising a non-ionic distyrylphenol alkoxylate and an ionic distyrylphenol alkoxylate.

27. A method of enhancing efficacy of pesticides in an agrochemical non-aqueous formulation comprising at least one organic solvent comprising contacting harmful insects, phytopathogenic fungi, their habit, breeding ground, food supply, plant, seed, soil, area, material or environment in which the harmful insects and/or phytopathogenic fungi are growing or may grow, or the materials, plants, seeds, soils, surfaces or spaces to be protected from attack or infestation by said harmful insects or phytopathogenic fungi with an effective amount of said agrochemical formulation comprising a mixture comprising a non-ionic distyrylphenol alkoxylate and a ionic distyrylphenol alkoxylate.

28. A method of combating harmful insects and/or phytopathogenic fungi, which comprises contacting said harmful insects and/or phytopathogenic fungi, their habit, breeding ground, food supply, plant, seed, soil, area, material or environment in which the harmful insects and/or phytopathogenic fungi are growing or may grow, or the materials, plants, seeds, soils, surfaces or spaces to be protected from attack or infestation by said harmful insects and/or phytopathogenic fungi with an effective amount of an agrochemical formulation as claimed in claim 16.

29. A method of controlling undesired vegetation, which comprises applying a herbicidally effective amount of an agrochemical formulation as claimed in claim 16 on plants, their habitat or on seed of said plants.

30. A seed treated with a formulation of claim 16.
